(19) United States
(12) Patent Application Publication
(10) Pub. No.: US 2020/0240674 A1
(43) Pub. Date: Jul. 30, 2020

(54) GASKET FOR DAMPER ASSEMBLY

(71) Applicant: Carnes Company, Inc., Pewaukee, WI (US)

(72) Inventors: Nicholas B. Howe, Madison, WI (US); Anthony R. Corners, Madison, WI (US)

(21) Appl. No.: 16/262,480

(22) Filed: Jan. 30, 2019

(51) Int. Cl. F24F 13/14; F24F 13/10; F16K 1/22; F16K 1/226

(52) U.S. Cl. CPC F24F 13/1406; F16K 1/2261; F16K 1/223; F24F 13/105

(57) ABSTRACT

A gasket including an outer surface with a patterned edge profile. The outer surface is configured to extend from an outer damper of a damper assembly. The damper assembly can be used in valve having a valve housing in which the damper assembly is positioned.

### BACKGROUND

The present invention relates to a damper assembly for use with a valve housing.

As air moves past a damper assembly in a valve housing, unwanted whistling and noise is often generated.

### SUMMARY

In one aspect, the present invention provides a gasket including an outer surface with a patterned edge profile. The outer surface is configured to extend from an outer damper of a damper assembly. The patterned edge profile may be defined by a plurality of concave portions and a plurality of convex portions. For example, one of the plurality of convex portions may be positioned between adjacent concave portions.

In another aspect, the invention provides a damper assembly configured to be positioned in a valve housing. The damper assembly includes a gasket assembly extending from a damper positioned within the valve housing. The gasket assembly has at least one gasket that has an outer surface with a patterned edge profile.

In yet another embodiment of the invention the invention provides a valve including a valve housing, a damper positioned within the valve housing and rotatable about an axis; and a gasket assembly extending from the damper. The gasket assembly has at least one gasket that has an outer surface with a patterned edge profile.

Other aspects of the invention will become apparent by consideration of the detailed description and accompanying drawings.

### BRIEF DESCRIPTION OF THE DRAWINGS

FIG. 1 is a perspective view of a valve housing including a damper assembly according to embodiment.

FIG. 2 is another perspective view of the valve housing with the damper assembly of FIG. 1 in another position.

FIG. 3 is a perspective view of the damper assembly of FIG. 1 including a gasket assembly.

FIG. 4 is an exploded view of a portion of the damper assembly of FIG. 1.

FIG. 5 is a front view of the gasket assembly of FIG. 3 having a gasket with a patterned edge profile.

FIG. 6 is a front view of another portion of the gasket assembly of FIG. 3 having another gasket with the same patterned edge profile as FIG. 5.

FIG. 7 is a perspective view of the valve housing of FIGS. 1-4 and including a damper assembly according to another embodiment.

FIG. 8 is a perspective view of the damper assembly of FIG. 7 including a gasket assembly.

FIG. 9 is an exploded view of a portion of the damper assembly of FIG. 7.

FIG. 10 is a perspective view of another valve housing including a damper assembly according to another embodiment.

FIG. 11 is a perspective view of the damper assembly of FIG. 10 including a gasket assembly.

FIG. 12 is an exploded view of a portion of the damper assembly of FIG. 10.

FIG. 13 is a front view of the gasket assembly of FIG. 10 having a gasket with a patterned edge profile.

FIG. 14 is a front view of the gasket assembly having a gasket with another patterned edge profile.

FIG. 15 is a front view of the gasket assembly having a gasket with another patterned edge profile.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

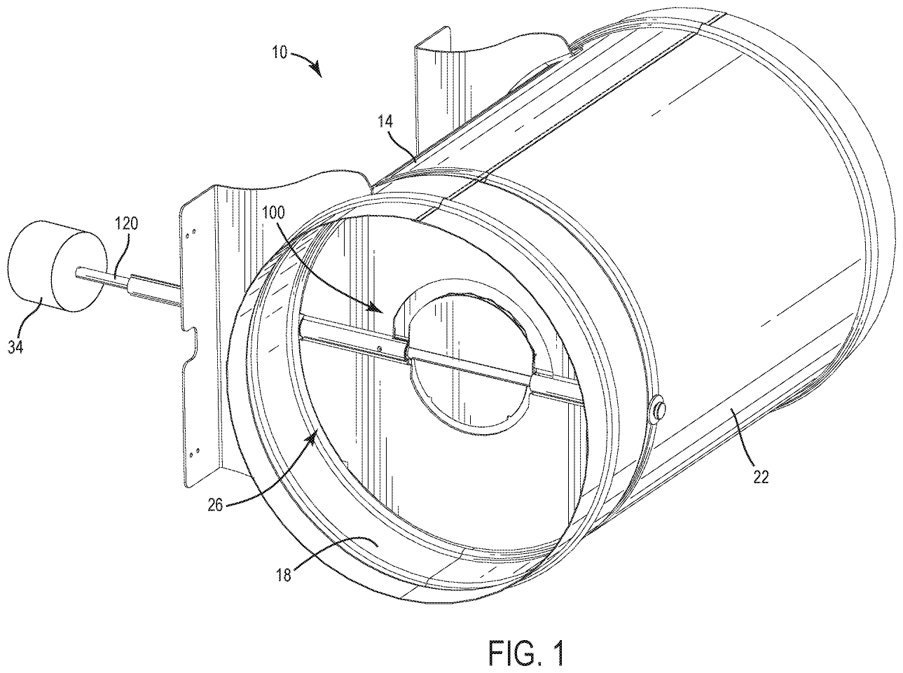

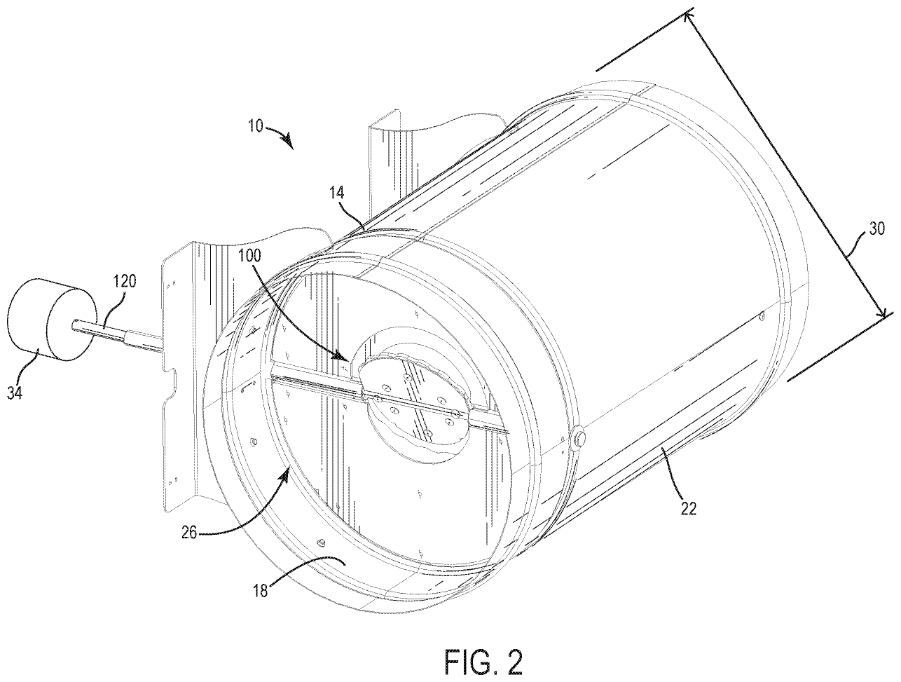

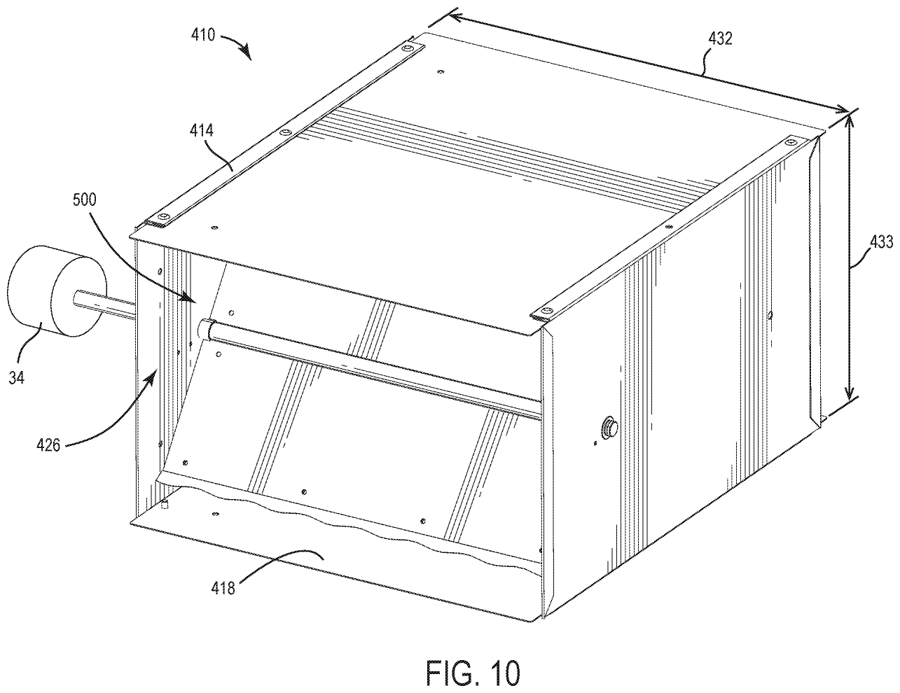

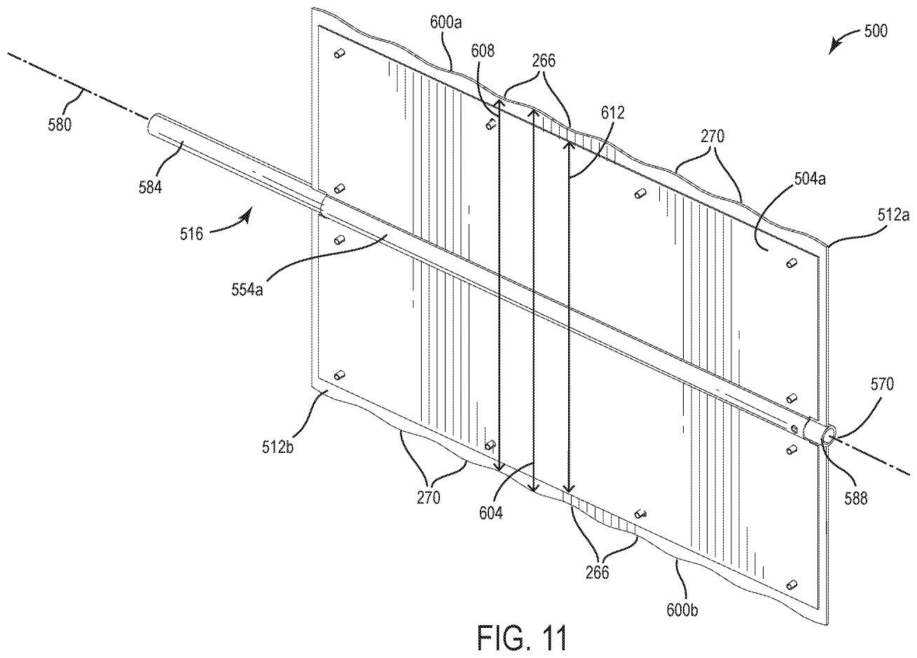

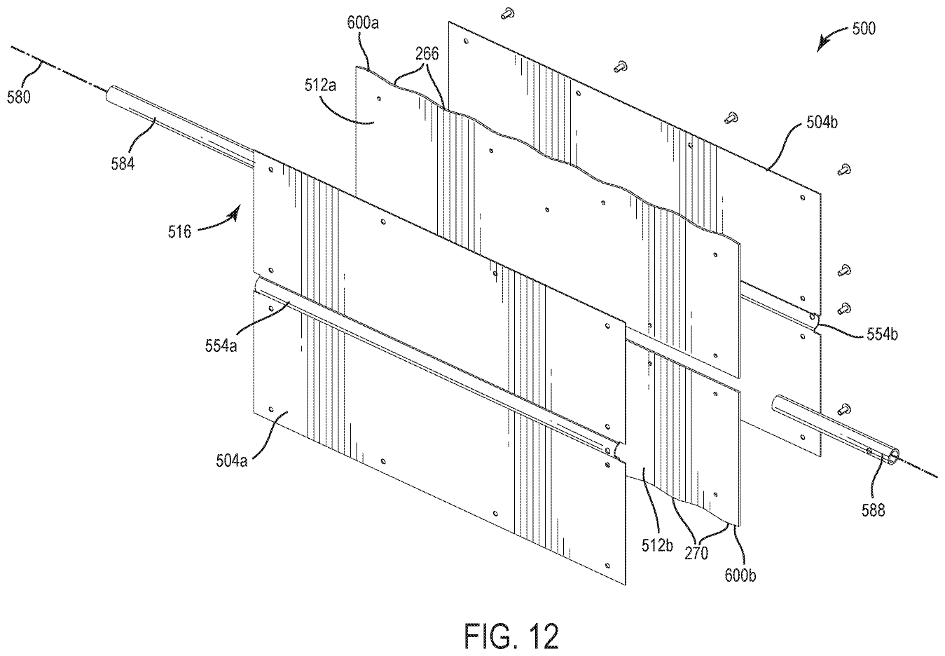

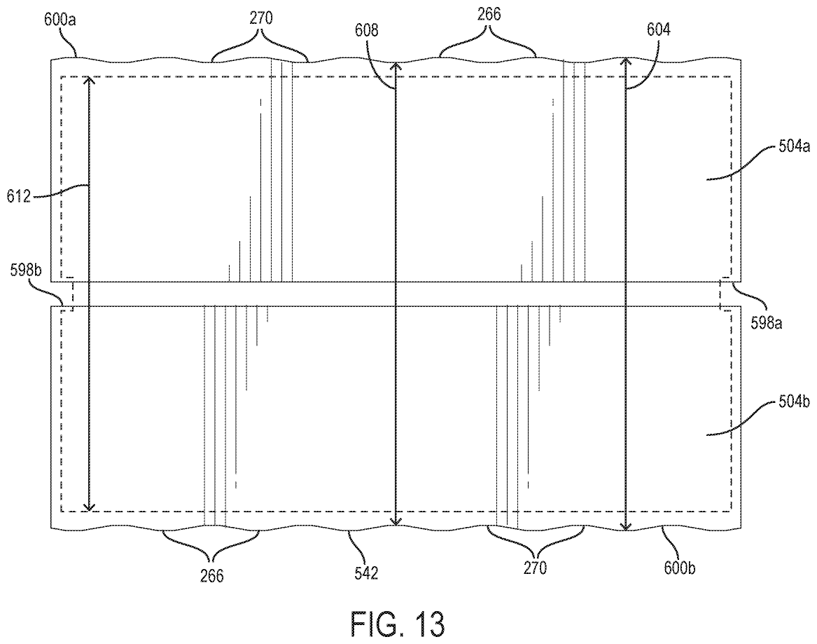

FIGS. 1 and 2 illustrate a valve 10 including a hollow housing 14 that has an inner surface 18 and an outer surface 22. The inner surface 18 defines a circular housing opening 26 having a housing inner diameter 30, and the outer surface 22 is configured to be coupled to an actuator assembly 34. In the illustrated embodiment, the housing 14 is cylindrical, but in other or additional embodiments, the housing could be any suitable shape. In the illustrated embodiment, the housing inner diameter 30 is approximately 11.8 inches, although in other or alternative embodiments the housing inner diameter 30 may have other dimensions, such as between 4 inches and 18 inches. The term approximately as used herein means plus or minus one inch. For example, FIGS. 10-13 illustrate a valve housing that is substantially rectangular, as will be discussed in greater detail below.

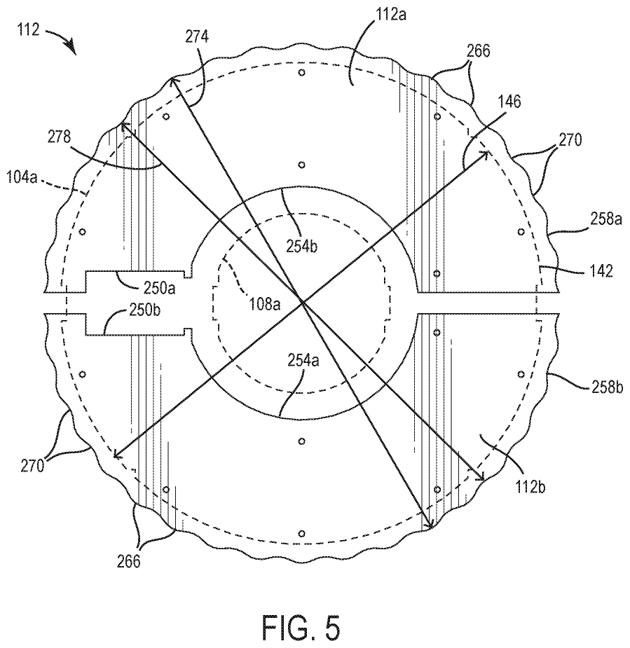

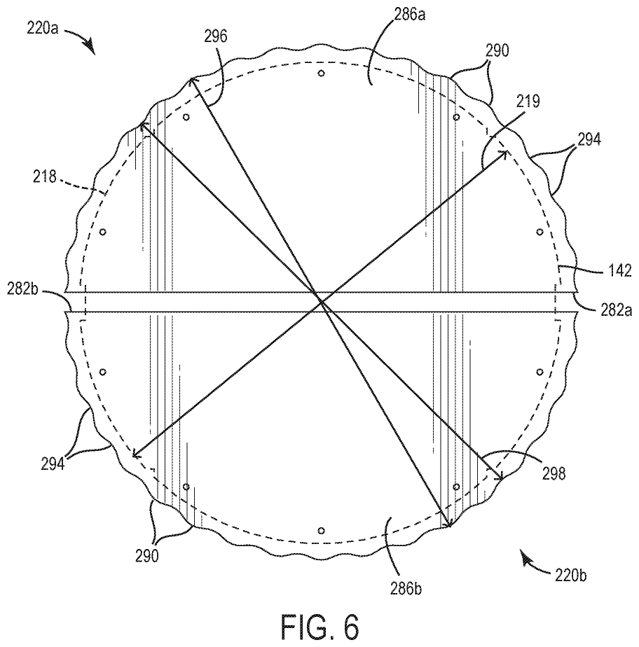

FIGS. 1-6 illustrate a damper assembly 100 that is configured to be coupled to the housing 14 and the actuator assembly 34. The damper assembly 100 includes an outer damper 104, an inner damper 108, a gasket assembly 112, a shaft 116, and a second shaft 120.

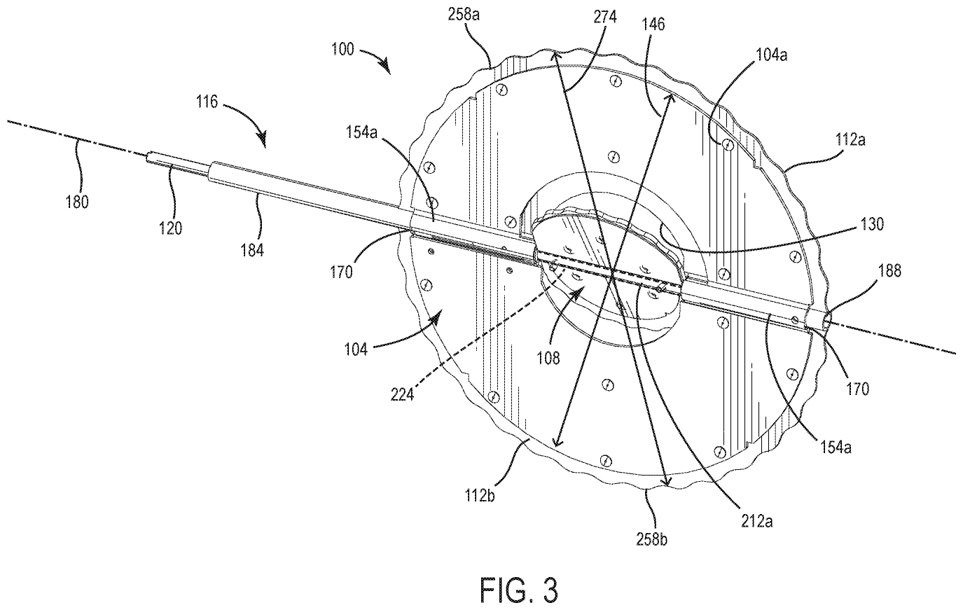

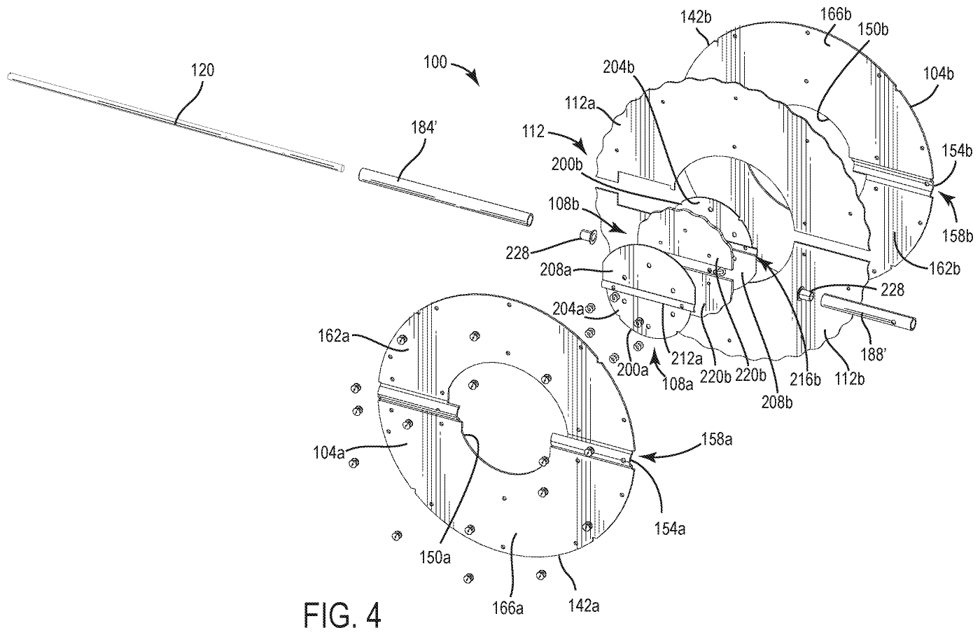

Referring to FIGS. 3 and 4, the outer damper 104 includes an outer damper opening 130. In the illustrated embodiment, the outer damper 104 is substantially circular and configured to be positioned within the circular opening 26 of the housing 14. In other or additional embodiments, the outer damper 104 may have other shapes such that the shape of the outer damper corresponds to the shape of the housing 14. The outer damper opening 30 of the illustrated embodiment has a diameter that is approximately ⅓ the housing diameter 30. The outer damper 104 defines a perimeter 142 and an outer damper diameter 146. In the illustrated embodiment, the outer damper diameter 146 is approximately 11.3 inches, although in other or alternative embodiments the outer damper diameter 146 may have other dimensions, such as between 3 inches and 17 inches.

The outer damper 104 further includes a first outer damper blade 104a and a second outer damper blade 104b. Each of the first and the second outer damper blades 104a, 104b includes an opening 150a, 150b, and projections 154a, 154b that extend from a surface of each of the first and second outer damper blades 104b, 104b. The projections 154a, 154b are semi-circular and therefore each defines an arcuate recess 158a, 158b. The projections 154a, 154b are aligned with one another on opposite sides of the respective opening 150a, 154b. In the other embodiments, the projections 154a, 154b may be any suitable shape. An upper portion 162a, 162b of each of the first and second outer damper blades 104a, 104b extends between a first side of the opening and the perimeter 142 and a lower portion 166a, 166b of each of the first and second outer damper blades 104a, 104b extends between a second side of the opening and the perimeter 142.

The outer damper 104 is oriented such that the upper portion 162a of the first outer damper blade 104 is aligned with the lower portion 166b of the second outer damper blade 104b. Accordingly, the lower portion 166a of the first outer damper blade is 104a aligned with the upper portion 162b of the second outer damper blade 104b. As a result, the projections 154 of the first and second outer damper blades 104a, 104b are aligned to define an aperture 170 in the outer damper, and the openings of each of the first and the second outer damper blades creates the outer damper opening 130.

Further with reference to FIGS. 3-4, the first shaft 116 is a dual-shaft that defines an axis of rotation 180 and is coupled to the outer damper 104 such that rotation of the first shaft 116 results in rotation of the outer damper 104. The dual-shaft includes a first shaft member 184 and second shaft member 188. Each of the first and second shaft members 184, 188 includes a hollow body 184′, 188′.

The first shaft member 184 is positioned between the first and second outer damper blades 104a, 104b on one side of the outer damper opening 130. In particular, the hollow body 184′ of the first shaft member 184 is positioned in the aperture 170 between the projections 154a, 154b of the first and the second outer damper blades 104a, 104b. The second shaft member 188 is positioned between the first and second outer damper blades 104a, 104b on an opposite side of the outer damper opening 130 from the first shaft member 184. In particular, the hollow body 188′ of the second shaft member 188 is positioned in the aperture 170 between the projections 154a, 154b of the first and second outer damper blades 104a, 104b.

With renewed reference to FIGS. 3 and 4, the inner damper 108 is positioned within the outer damper opening 130, and includes a first inner damper blade 108a and a second inner 108b damper blade. Each of the first and the second inner damper blades 108a, 108b includes a perimeter 200a, 200b defining an upper arcuate portion 204a, 204b and a lower arcuate portion 208a, 208b. Projections 212a, 212b extend from a surface of each of the first and second inner damper blades 108a, 108b. The projections 212a, 212b are semi-circular and therefore define arcuate recesses 216a, 216b (only 216b is shown). In the other embodiments, the projections 212a, 212b may be any suitable shape. The inner damper 108 defines a perimeter 218 and an inner damper diameter 219. In the illustrated embodiment, the inner damper diameter 219 is approximately 4.1 inches, although in other or alternative embodiments the inner damper diameter 219 may have other dimensions, such between 1 inch and 7 inches.

The inner damper 108 is oriented such that the upper arcuate portion 204a of first inner damper blade 108a is aligned with the lower arcuate portion 208b of the second inner damper blade 108b. Accordingly, the lower portion 208a of the first inner damper blade 108a is aligned with the upper portion 204b of the second inner damper blade 108b. As a result of this orientation, the projections 212a, 212b of the first and second inner damper blades are aligned and define an aperture 224 in the inner damper 108.

As shown in FIGS. 3 and 4, the second shaft 120 is coupled to the inner damper 108 and is rotatable out the axis of rotation 180. In particular, the second shaft 120 extends between and is coupled to the projections 212a, 212b of the first and second inner damper blades 108a, 108b. The second shaft 120 also extends through the hollow bodies 184′, 188′ of the first shaft 116. There are stoppers 228 between the first and the second shafts 116, 120 to prevent axial movement of the first and second shafts 116, 120 relative to one another.

With respect to FIGS. 3-5, the gasket assembly 112 is coupled to the damper assembly 100. The gasket assembly includes a first outer gasket 112a and a second outer gasket 112b. The first outer gasket 112a and the second outer gasket 112b are coupled to the outer damper 104 on opposite sides of the outer damper opening 130. In the embodiment illustrated in FIGS. 1-5, the first and second outer gaskets 112a, 112b are positioned between the first and second outer damper blades 104a, 104b. In particular, the first outer gasket 112a is positioned on a first side of the projections 154 and the second outer gasket 112b is positioned on a second side of the projections 154. In other or additional embodiments, the gasket assembly 112 may be a single gasket that is integrally formed or coupled to the outer damper 104 such that the gasket assembly is concentric with the outer damper 104. Alternatively, in other embodiments, the gasket assembly 112 may substantially cover all or a portion of the outer damper 104.

Each of the first and second outer gaskets 112a,112b has a body that is semi-circular and that has a first or inner arcuate surface 254a, 254b and a second or outer arcuate surface 258a, 258b. The inner arcuate surface 254a, 254b is substantially smooth and is positioned adjacent to the first side of the opening 150a, 150b of each of the respective first and second outer damper blades 104a, 104b. The inner arcuate surface 254a, 254b is substantially the same size as the first side of the first and second outer damper blades 104a, 104b. The outer arcuate surface 258a, 258b has an undulating surface that defines a patterned edge profile. In the context of this application, patterned means having repeating peaks (i.e., radially raised portions) and valleys (i.e., radially lowered portions).

As shown FIGS. 2-5, the patterned edge profile is defined by a plurality of concave portions 266 (i.e., peaks) and plurality of convex portions 270 (i.e., valleys). One convex portion 270 is positioned between adjacent concave portions 266. The outer arcuate surfaces 258a, 258b of the first and second outer gaskets 112a, 112b define gasket major diameter 274 and a gasket minor diameter 278. The gasket major and minor diameters 274, 278 are greater than the outer damper diameter 146 such that the outer arcuate surface 258, 258b of each of the first and second outer gaskets 112a, 112b extends from the outer damper 104. Additionally, both the gasket major and minor diameters 274, 278 are larger than the housing inner diameter 30. In the illustrated embodiment, the major gasket diameter 274 is approximately 12.2 inches and the minor gasket diameter 278 is approximately 11.9 inches, although in other or additional embodiments the gasket major diameter 274 may have other dimensions, such as between 3.9 inches and 17.9 inches, and the gasket minor diameter 278 may have other dimensions, such as between 3.6 inches and 17.6 inches. Moreover, a distance between each peak 266 and an adjacent valley 270 in the illustrated embodiment is approximately ⅛ inch. The patterned edge profile of the first and second outer gaskets 112a, 112b, and therefore the gasket assembly 112 as a whole, reduces the outer edge whistling and air noise at positions of the damper assembly 100 (particularly when the outer damper 104 is open or partially open) as compared to gasket assemblies without the patterned edge profile. In fact, the patterned edge profile of the gasket assembly 112 breaks up the harmonics of the air so that standing waves (noise) are either reduced or not generated.

With respect to FIG. 1-6, the gasket assembly further includes a first inner gasket 220a and a second inner gasket 220b, which are positioned between the first and second inner damper blades 108a, 108b in the illustrated embodiment. In other or additional embodiments, a single gasket may be integrally formed or coupled to the inner damper 108 such that the gasket is concentric with the inner damper 108. Alternatively, in other embodiments, the gaskets 220 may substantially cover all or a portion of the inner damper 108. Each of the first and second inner gaskets 220a, 220b has a body that is semi-circular and an inner flat surface 282a, 282b and a second or outer arcuate surface 286a, 286b. The flat surfaces 282a, 282b are substantially smooth and are positioned adjacent to the projections 212a, 212b of the first and second inner damper blades 108a, 108b. Like the outer arcuate surfaces 258a, 258b, the outer arcuate surfaces 286a, 286b have an undulating surface that defines a patterned edge profile. The patterned edge profile is defined by a plurality of concave portions 290 (i.e., peaks) and plurality of convex portions 294 (i.e., valleys). One convex portion 290 is positioned between adjacent concave portions 286. The outer arcuate surfaces 286 of the first and second inner gaskets 220a, 220b define a gasket major diameter 296 and a gasket minor diameter 298. The gasket major and minor diameters 296, 298 are greater than the inner damper 108 diameter 219 such that the outer arcuate surfaces 286a, 286b of each of the first and second inner gaskets 220a, 220b extends from the inner damper 220. In the illustrated embodiment, the major gasket diameter 296 is approximately 4.5 inches and the minor gasket diameter 298 is approximately 4.4 inches, although in other or additional embodiments the gasket major diameter 296 may have other dimensions, such as between 1.4 inches and 7.4 inches, and the gasket minor diameter 298 may have other dimensions, such as between 1.3 inches and 7.3 inches. Moreover, a distance between each peak 290 and an adjacent valley 294 in the illustrated embodiment is approximately ⅛ inch. The patterned edge profile of the first and second inner gaskets 220a, 220b, and therefore the first and second inner gaskets 220a, 220b as a whole, reduces the outer edge whistling and air noise at positions of the damper assembly 100 (particularly when the inner damper 108 is open or partially open) as compared to gasket assemblies without the patterned edge profile. In fact, the patterned edge profile of the first and second inner gaskets 220a, 220b breaks up the harmonics of the air so that standing waves (noise) are either reduced or not generated.

It should be appreciated that it is within the scope of invention that the gasket assembly 112 may be coupled to the inner surface 18 of the valve housing 14. In other words, the gasket assembly may include one or more gaskets that extend from the inner surface of the valve housing and have an arcuate surface having a patterned edge profile.

In use, the outer damper 104 and the inner damper 108 are configured to rotate relative to one another and the valve housing 14 to control fluid flow through the housing 14. To this end, the first shaft 112 is coupled to the actuator assembly 34 and is actuatable to rotate the outer damper 104 about the axis of rotation 180 to change the position of the outer damper 104, and therefore the gasket assembly 112, relative to the inner surface 18 of the housing 14. Similarly, the second shaft 120 is coupled to the actuator assembly 34 and is actuatable to rotate the inner damper 108 about the axis of rotation 180 to change the position of the inner damper 108 relative to the outer damper 104.

The embodiment of FIGS. 1-6 is merely exemplary. Both the valve and damper assemblies may have other suitable configurations.

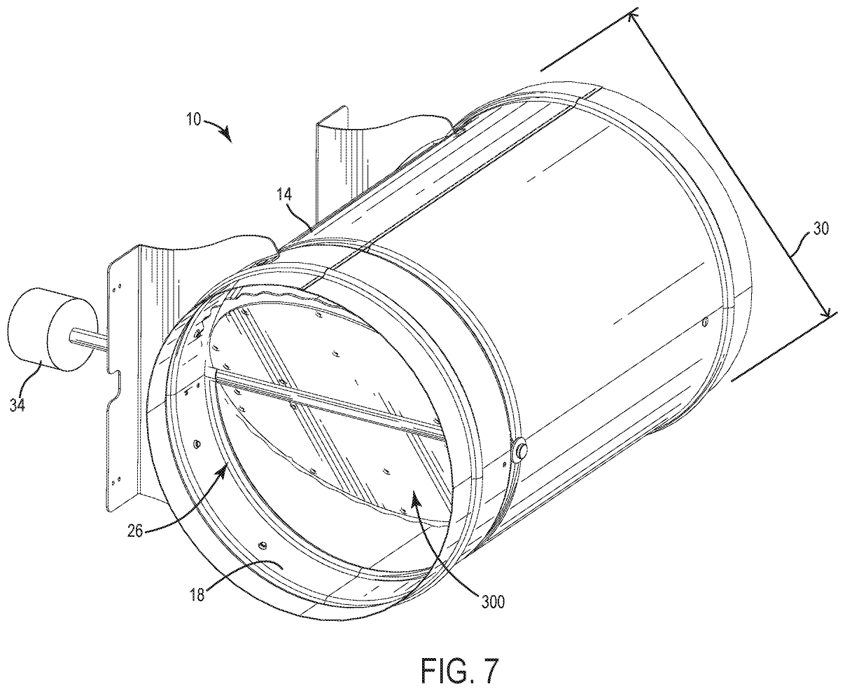

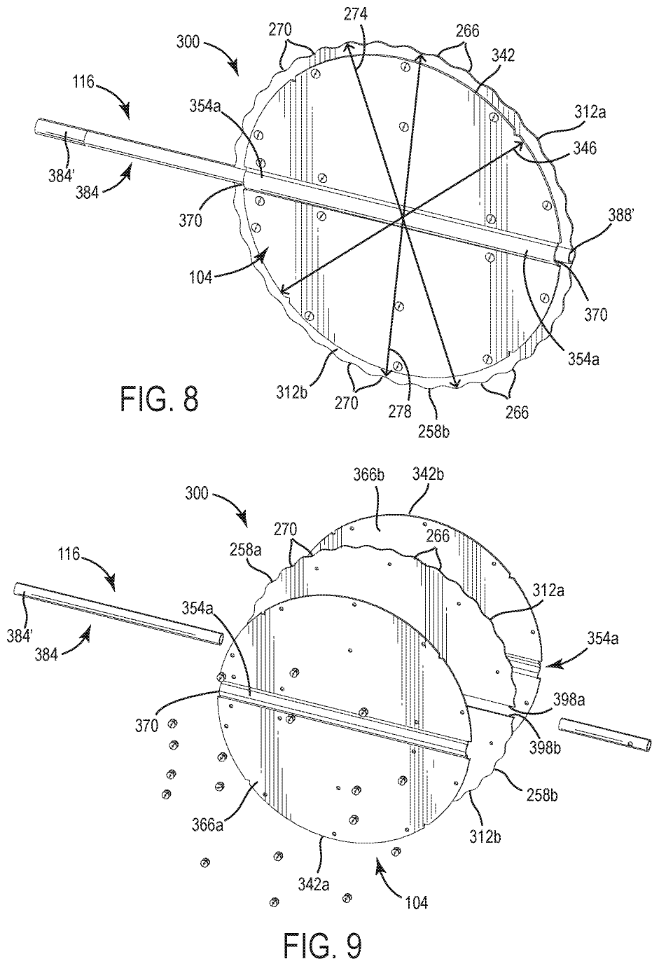

FIGS. 7-9 illustrate the valve assembly 10 of FIGS. 1-4 including another damper assembly 300 that is configured to be coupled to the housing 14 and the actuator assembly 34. The damper assembly 300 is a single damper assembly and includes a damper 304, a gasket assembly 312, and a shaft 316.

Like the damper 304 of FIGS. 1-6, the damper of FIGS. 7-9 is substantially circular and configured to be positioned within the circular opening 26 of the housing 14. In other or additional embodiments, the damper 304 may have other shapes such that the shape of the outer damper corresponds to the shape of the housing 14. The damper 304 defines a perimeter 342 and a damper diameter 346.

The damper 304 further includes a first damper blade 304a and a second damper blade 304b. Each of the first and the second damper blades 304a, 304b includes projections 354a, 354b that extend from a surface of each of the first and second damper blades 304b, 304b. The projections 354a, 354b are semi-circular, and therefore each defines an arcuate recess 358a, 358b. In the other embodiments, the projections 354a, 354b may be any suitable shape. The damper 304 is oriented such that the projections 354a, 354b of the first and second damper blades 304a, 304b are aligned to define an aperture 370 in the damper 304.

Further with reference to FIGS. 7-9, the shaft 316 is a dual-shaft that defines an axis of rotation 380 and is coupled to the outer damper 304 such that rotation of the first shaft 316 results in rotation of the outer damper 304. The dual-shaft includes a first shaft member 384 and second shaft member 388. Each of the first and second shaft members 384, 388 includes a hollow body 384′, 388′. The first and second shaft members 384 are positioned between the first and second damper blades 304a, 304b. In particular, the hollow bodies 384′, 388′ of the first shaft member and second shaft members 384, 388 are positioned in the aperture 370 between the projections 354a, 354b of the first and the second damper blades 304a, 304b.

FIGS. 7-9 illustrate that the gasket assembly 312 is coupled to the damper assembly 300. The gasket assembly includes a first gasket 312a and a second gasket 312b. The first gasket 312a and the second gasket 312b are coupled to the damper 304. In the embodiment illustrated in FIGS. 7-9, the first and second gaskets 312a, 312b are positioned between the first and second damper blades 304a, 304b. In particular, the first gasket 312a is positioned on a first side of the projections 354 and the second gasket 312b is positioned on a second side of the projections 354. In other or additional embodiments, the gasket assembly 312 may be a single gasket that is integrally formed or coupled to the damper 304 such that the gasket assembly is concentric with the damper 304. Alternatively, in other embodiments, the gasket assembly 312 may substantially cover all or a portion of the damper 304.

Like the gaskets 112a, 112b of FIGS. 3-6, each of the first and second outer gaskets 312a, 312b has a body that is semi-circular including a first or flat surface 398a, 358b and a second or outer arcuate surface 258a, 258b. The inner flat surfaces 398a, 398b are substantially smooth and re positioned adjacent to the projection 354a, 354b on opposite sides. Each of the outer arcuate surface 258a, 258b has an undulating surface that defines the patterned edge profile discussed above with respect to FIGS. 1-6. For the sake of brevity, the merits of the patterned edge profile will not be repeated, but apply equally to the embodiment of FIGS. 7-9.

It should be appreciated that it is within the scope of invention that the gasket assembly 312 may be coupled to the inner surface 18 of the valve housing 14. In other words, the gasket assembly may include one or more gaskets that extend from the inner surface of the valve housing and have an arcuate surface having a patterned edge profile.

In use, the damper 304 is configured to rotate relative to the valve housing 14 to control fluid flow through the housing 14. To this end, the first shaft 312 is coupled to the actuator assembly 34 and is actuatable to rotate the damper 304 about the axis of rotation 380 to change the position of the damper 304, and therefore the gasket assembly 312, relative to the inner surface 18 of the housing 14.

FIGS. 10-13 illustrate a valve assembly 410 including another damper assembly 500 that is configured to be coupled to the actuator assembly 34. The valve assembly 410 is substantially similar to the valve assembly 10 of FIGS. 1 and 2 except that relevant components are rectangular rather than circular or cylindrical. Similarly, the damper assembly 400 is substantially similar to the damper assembly 300 of FIGS. 7-9 except that relevant components are rectangular rather than circular or cylindrical. Accordingly, like structure for the valve assembly 410 will be shown with like reference numerals starting in the 400 series, like structure for the damper assembly 500 will be shown with like reference numerals starting in the 500 series, and only the differences will be discussed herein. As shown in FIGS. 10-13, the valve housing 414 is rectangular 426. Accordingly, the inner surface 418 defines a rectangular housing opening 426 having a first housing inner distance 432 and a second housing distance 433. In the illustrated embodiment the first housing distance 432 is approximately 14.7 inches and the second housing distance 433 is approximately 10.2 inches, although in other or additional embodiments, the first housing distance 432 may have other dimensions, such as between 10 inches and 30 inches, and the second housing distance 433 may have other dimensions, such as between 4 inches and 30 inches. Similarly, the damper 504 (i.e., the damper blades 504a, 504b) and gasket assembly 512 are rectangular.

More specifically, the gasket assembly 512 includes a first gasket 512a and a second gasket 512b. The first gasket 512a and the second gasket 512b are coupled to the damper 504. In the embodiment illustrated in FIGS. 10-13, the first and second gaskets 512a, 512b are positioned between the first and second damper blades 504a, 504b. In particular, the first gasket 512a is positioned on a first side of the projections 554 and the second gasket 512b is positioned on a second side of the projections 554. In other or additional embodiments, the gasket assembly 512 may be a single gasket that is integrally formed or coupled to the damper 504 such that the gasket assembly is aligned with the damper 504. Alternatively, in other embodiments, the gasket assembly 512 may substantially cover all or a portion of the damper 504.

Each of the first and second outer gaskets 512a, 512b has a body that is rectangular and includes a first or flat surface 598a, 598b and a second or outer surface 600a, 600b. The inner flat surfaces 598a, 598b are substantially smooth and are positioned adjacent to the projection 554a, 554b on opposite sides. Each of the outer surface 600a, 600b has an undulating surface that defines the patterned edge profile discussed above with respect to FIGS. 1-6. The outer surfaces 600a, 600b of the first and second gaskets 512a, 512b define gasket major distance 604 and a gasket minor distance 608. The gasket major and minor distances 604, 608 are greater than an damper distance 612 such that the outer surface 600a, 600b of each of the first and second gaskets 512a, 512b extends from the damper 504. In the illustrated embodiment, the damper distance 612 is approximately 9.4 inches, although in other or additional embodiments, the damper distance 612 may have other dimensions, such as between 3 inches and 29 inches. In comparison, in the illustrated embodiment, the gasket major distance 604 is approximately 10.3 inches and the gasket minor distance 608 is approximately 10.0 inches. In other or additional embodiments, the gasket major distance 604 may have other dimensions, such as between 3.9 inches and 29.9 inches and the gasket minor distance 608 may have other dimensions, such as between 3.6 inches and 29.6 inches. Moreover, a distance between each peak 266 and an adjacent valley 270 in the illustrated embodiment is approximately ⅛ inch. For the sake of brevity, the merits of the patterned edge profile will not be repeated, but apply equally to the embodiment of FIGS. 10-13.

It should be appreciated that it is within the scope of invention that the gasket assembly 512 may be coupled to the inner surface 418 of the valve housing 414. In other words, the gasket assembly may include one or more gaskets that extend from the inner surface of the valve housing and have an arcuate surface having a patterned edge profile.

In use, the damper 504 is configured to rotate relative to the valve housing 414 to control fluid flow through the housing 414. To this end, the first shaft 512 is coupled to the actuator assembly 34 and is actuatable to rotate the damper 504 about the axis of rotation 580 to change the position of the damper 504, and therefore the gasket assembly 512, relative to the inner surface 418 of the housing 414.

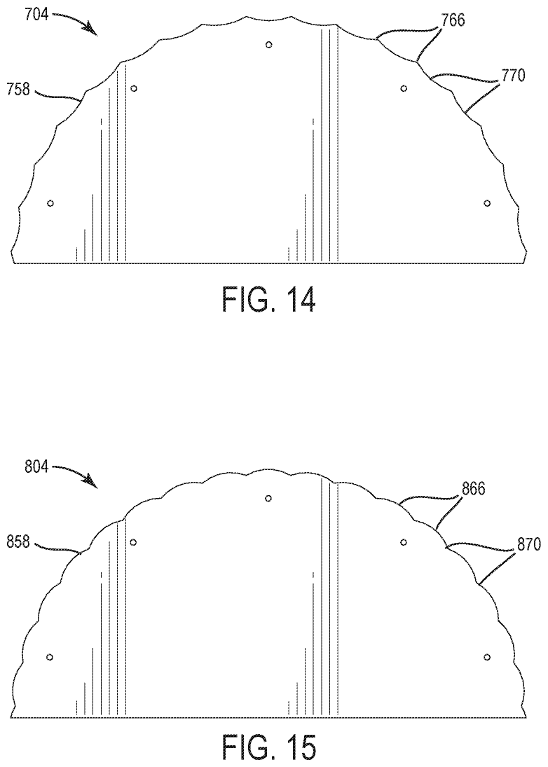

FIGS. 14 and 15 illustrate gaskets 704, 804 that have other patterned edge profiles. It is within the spirit and the scope of the invention that any of the gaskets shown and described above with respect to FIGS. 1-13 may have the patterned edge profiles of the gaskets 704, 804 of FIGS. 14 and 15 or any other suitable patterned edge profile. As shown FIG. 14, the gasket 704 includes outer arcuate surfaces 758 in which the patterned edge profiles are defined by a plurality of pointed portions 766 (i.e., peaks) and plurality of convex portions 770 (i.e., valleys). One convex portion 770 is positioned between adjacent pointed portions 766. As shown FIG. 15, the gasket 804 includes outer arcuate surfaces 858 in which the patterned edge profiles are defined by a plurality of concave portions 866 (i.e., peaks) and plurality of V-shaped or pointed portions 870 (i.e., valleys). One V-shaped portion 870 is positioned between adjacent concave portions 866.

The patterned edge profile of the gaskets 704, 804 shown in FIGS. 14 and 15 reduce the outer edge whistling and air noise when used in any of the damper assemblies shown and described herein as compared to gasket assemblies without the patterned edge profiles. In fact, when used, the patterned edge profile of the gasket gaskets 704, 804 breaks up the harmonics of the air so that standing waves (noise) are either reduced or not generated.

Various features and advantages of the invention are set forth in the following claims.

What is claimed is:

1. A damper assembly configured to be positioned in a valve housing, the damper assembly comprising:
a gasket assembly extending from a damper positioned within the valve housing, the gasket assembly having at least one gasket that has an outer surface with a patterned edge profile.

2. The damper assembly of claim 1, wherein the gasket assembly includes a first gasket and a second gasket, each of the first and second gaskets having an outer surface with a patterned edge profile.

3. The damper assembly of claim 1, wherein the at least one gasket substantially covers all or a portion of the damper.

4. The damper assembly of claim 1, wherein the damper defines a first diameter and the gasket assembly defines a second diameter that is greater than the first diameter.

5. The damper assembly of claim 1, wherein the damper includes a first damper blade and a second damper blade, the gasket being positioned between the first damper blade and the second damper blade.

6. The damper assembly of claim 5, wherein the patterned edge profile of the outer surface of the gasket includes a plurality of concave portions and a plurality of convex portions, one of the plurality of convex portions being positioned between adjacent concave portions of the plurality of concave portions.

7. The damper assembly of claim 6, wherein the damper defines a first diameter and the at least one gasket defines a second diameter that is greater than the first diameter.

8. The damper assembly of claim 1, wherein the gasket assembly is either circular or rectangular.

9. A valve comprising:
a valve housing;
a damper positioned within the valve housing and rotatable about an axis; and
a gasket assembly extending from the damper, the gasket assembly having at least one gasket that has an outer surface with a patterned edge profile.

10. The valve of claim 9, wherein the damper defines a first diameter and the gasket assembly defines a second diameter that is greater than the first diameter.

11. The valve of claim 9, wherein the damper includes a first damper blade and a second damper blade, the gasket assembly being positioned between the first damper blade and the second damper blade.

12. The valve of claim 9, wherein the gasket assembly includes more than one gasket, each of the gaskets having an outer surface with a plurality of concave portions and a plurality of convex portions, one of the plurality of convex portions being positioned between adjacent concave portions of the plurality of concave portions.

13. The valve of claim 12, wherein the damper defines a first diameter, and the gaskets define a second diameter that is greater than the first diameter.

14. The valve of claim 9, wherein the patterned edge profile of the outer surface of the at least one gasket includes a plurality of concave portions and a plurality of convex portions, one of the plurality of convex portions being positioned between adjacent concave portions of the plurality of concave portions.

15. The valve of claim 9, wherein the valve housing defines a first diameter and the gasket assembly defines a second diameter, the second diameter being larger than the second first diameter.

16. A gasket comprising an outer surface with a patterned edge profile, the outer surface configured to extend from an outer damper of a damper assembly.

17. The gasket of claim 16, wherein the patterned edge profile is defined by a plurality of concave portions and a plurality of convex portions, one of the plurality of convex portions being positioned between adjacent concave portions of the plurality of concave portions.

18. The gasket of claim 16, wherein the patterned edge profile is defined by a plurality of pointed portions and a plurality of convex portions, one of the plurality of convex portions being positioned between adjacent pointed portions of the plurality of pointed portions.

19. The gasket of claim 16, wherein the patterned edge profile is defined by a plurality of concave portions and a plurality of V-shaped portions, one of the plurality of V-shaped portions being positioned between adjacent concave portions of the plurality of concave portions.
